(19) United States
(12) Patent Application Publication
(10) Pub. No.: US 2024/0423193 A1
(43) Pub. Date: Dec. 26, 2024

(54) MOSQUITO REPELLING FAN

(71) Applicant: Wenjie LI, Guangzhou (CN)

(72) Inventor: Wenjie LI, Guangzhou (CN)

(21) Appl. No.: 18/415,198

(22) Filed: Jan. 17, 2024

(30) Foreign Application Priority Data
Jun. 20, 2023 (CN) 202310740737.6

(51) Int. Cl. A01M 29/12

(52) U.S. Cl. CPC A01M 29/12

(57) ABSTRACT

Disclosed is a mosquito repelling fan. The mosquito repelling fan is used in cooperation with a tablet, and includes a shell and a fan assembly installed in the shell, the fan assembly blows air in a direction out of the shell, an installation plate is disposed behind the fan assembly, an installation space is formed between the installation plate and the fan assembly, and the tablet is detachably and replaceably installed in the installation space; the tablet is prepared by soaking a flaky base material in a repellent, and the repellent includes Picaridin; and a hollow-out area is disposed at a position, corresponding to an air outlet of the fan assembly, on the shell. The mosquito repelling fan of the application is low in work temperature, so that the energy consumption is low, and an energy supply element with large volume and large mass does not need to be configured.

### CROSS-REFERENCE TO RELATED APPLICATIONS

This application claims priority to Chinese Patent Application No. 202310740737.6, filed on Jun. 20, 2023, which is incorporated herein by reference in its entirety.

### TECHNICAL FIELD

The application relates to the technical field of mosquito repelling devices, and in particular to a mosquito repelling fan.

### BACKGROUND

Common mosquito repelling methods using a chemical repellent in daily life include applying the mosquito repellent directly to skin and using a spray head to produce a spray. For use of the mosquito repellent in the form of spray or apply, in order to achieve a better diffusion effect, volatile agents such as alcohol and glycerol need to be added into the repellent to promote volatilization and diffusion effects, but sticky discomfort may be generated on the skin, and potential safety hazards may also be caused to people with sensitive skin.

### SUMMARY

The application provides a mosquito repelling fan, for solving the problems that in the relevant art, for use of the mosquito repellent in the form of spray or apply, sticky discomfort may be generated on the skin, and potential safety hazards may also be caused to people with sensitive skin.

In order to realize the purpose, the technical solution adopted by the application is as follows.

A mosquito repelling fan is used in cooperation with a tablet, and includes a shell and a fan assembly installed in the shell, the fan assembly blows air in a direction out of the shell, an installation plate is disposed behind the fan assembly, an installation space is formed between the installation plate and the fan assembly, and the tablet is detachably and replaceably installed in the installation space.

The tablet is prepared by soaking a flaky base material in a repellent, and the repellent includes Picaridin.

A hollow-out area is disposed at a position, corresponding to an air outlet of the fan assembly, on the shell.

Furthermore, an installation groove is formed in the shell, the installation groove communicates with the installation space, and the tablet is inserted into the installation space from the installation groove.

Furthermore, the fan assembly includes fan blades, a motor, a bearing and a fan blade support, the motor is installed at the top of the fan blade support, a connecting rod is disposed at the rear end of the fan blade, which is connected with the motor through the connecting rod and driven by the motor, and the bearing sleeves outside the connecting rod.

Furthermore, the mosquito repelling fan further includes a control module, the control module includes a circuit board, an indicator light and a key, and the control module is electrically connected with the fan assembly.

Furthermore, the indicator light and the key are disposed on the circuit board and face the air outlet side of the mosquito repelling fan.

The control module further includes a keycap installed on the surface of the key, and the keycap and the indicator light penetrate out of the surface of the shell.

A power supply interface is further disposed at the end part of one side of the circuit board, and a power supply opening is formed in the position, corresponding to the power supply interface, of the shell and configured for connecting an external wire to the power supply opening.

The type of the power supply interface is any one of USB interfaces of Type-A, Mini-B, Micro-B and Type-C.

Furthermore, the installation plate has a heating function, and the temperature of the electric heating plate is regulated and controlled by the control module.

The speed of air generated by the fan assembly is regulated and controlled by the control module.

Furthermore, the mosquito repelling fan further includes a power supply element disposed in the shell, and the power supply element is located on the side, deviating from the fan assembly, of the installation plate.

The power supply element is electrically connected with the fan assembly and the control module, and a partition plate is lined between the power supply element and the installation plate.

Furthermore, the temperature of the installation plate has a plurality of gears, and a plurality of indicator lights are available, which respectively indicate each temperature gear of the installation plate and a switch of the mosquito repelling fan.

Furthermore, the work temperature of the installation plate is greater than 40° C. and less than 120° C.

Furthermore, the repellent further includes one or more of BAAPE (ethyl butylacetylaminopropionate), methyl nonyl ketone and DEET (N,N-Diethyl-3-methylbenzamide).

The application has the following beneficial effects.

Firstly, the mosquito repelling fan of the application is low in work temperature, so that the energy consumption is low, and an energy supply element with large volume and large mass does not need to be configured, so that the whole mosquito repelling fan is miniaturized.

Secondly, the mosquito repelling fan of the application uses the tablet soaked with Picaridin with good volatilization as a consumption medicine, which has no requirement on the specific placing angle of the mosquito repelling fan, so that the degree of freedom is higher during use of a user.

Lastly, there is no need to spray or apply the medicine to the skin, so that the use is safer.

### BRIEF DESCRIPTION OF THE DRAWINGS

FIG. 1 is a schematic diagram of an exploded view of a mosquito repelling fan.

FIG. 2 is a schematic diagram of a cross-sectional view of a mosquito repelling fan.

### DETAILED DESCRIPTION OF THE EMBODIMENTS

In order to make the purpose, the technical solutions and the advantages of the application clearer, the technical solutions of the application will be clearly and completely described below in combination with the embodiments of the application. It is to be noted that the described embodiments are only a part but not all of the embodiments of the application. All other embodiments obtained by those of ordinary skill in the art based on the embodiments of the application without creative efforts shall fall within the protection scope of the application.

It is to be noted that if the embodiments of the application contain directional indications (such as up, down, left, right, front, back, top, bottom, inside, outside, vertical, transverse, longitudinal, counterclockwise, clockwise, circumferential, radial, axial . . . ), the directional indications are only used to explain the relative position relationship and motion between the components under a specific attitude (as shown in the attached figures). If the specific attitude changes, the directional indication will change accordingly.

In the embodiments of the application, the term “and/or” is only an association relationship for describing an associated object, and indicates that three relationships may exist, for example, A and/or B, and may indicate: A exists alone, A and B exist simultaneously, and B exists alone.

In the embodiments of the application, terms “first” and “second” are only adopted for description and should not be understood to indicate or imply relative importance or implicitly indicate the number of indicated technical features. Therefore, a feature defined by “first” and “second” may explicitly or implicitly indicate inclusion of at least one such feature. In description of the application, the terms “comprising”, “having” and any variations thereof are intended to cover a non-exclusive inclusion. For example, systems, products or devices including a series of components or units are not limited to listed components or units, but further alternatively include components or units not listed, or alternatively include other components or units inherent to such products or devices. In the description of the application, “plurality” means two or more, for example, two, three and the like, unless otherwise limited definitely and specifically.

“Embodiment” mentioned herein means that specific features, structures or characteristics described in conjunction with the embodiments are included in at least one embodiment of the application. The appearances of the term in various places in the specification are not necessarily all referring to the same embodiment, nor are separate or alternative embodiments mutually exclusive of other embodiments. It is explicitly and implicitly understood by the skilled in the art that the embodiments described herein may be combined with other embodiments.

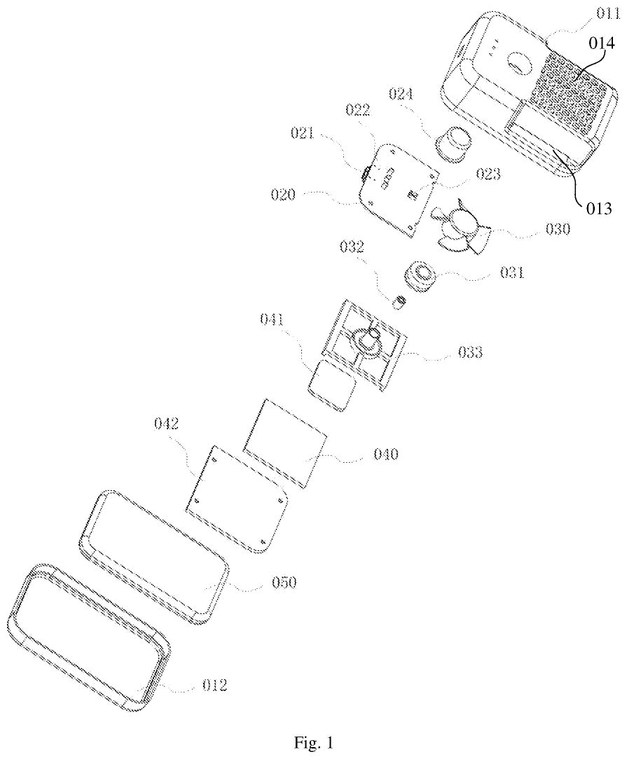

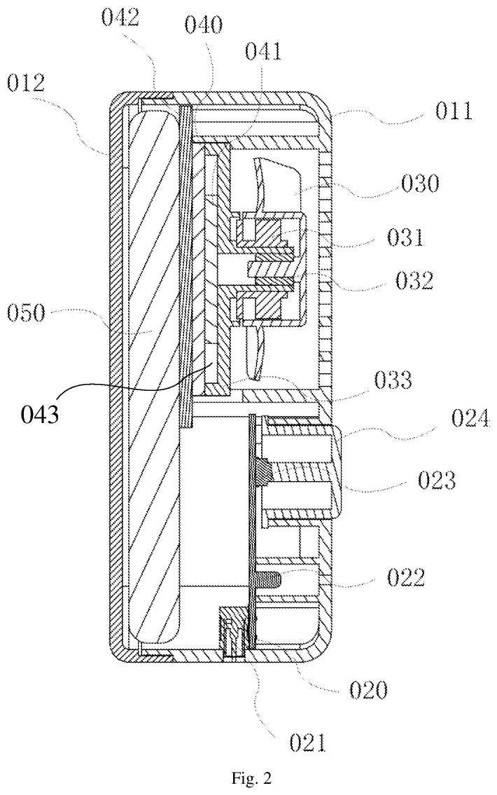

As shown in FIGS. 1 and 2, the application provides a mosquito repelling fan, which mainly includes a shell and a fan assembly and a control module installed in the shell, the fan assembly is installed in the shell, an installation plate 040 is disposed behind the fan assembly in the mosquito repelling fan for replaceably and detachably installing a tablet 041, and a power supply element 050 is further disposed in the mosquito repelling fan for supplying power for the control module and the fan assembly.

Specifically, the shell includes a top shell 011 and a bottom shell 012, and the top shell 011 and the bottom shell 012 are connected up and down for covering the fan assembly, the control module, the installation plate 040 and the power supply element 050 inside; the fan assembly provides air to the outside of the shell, an area, corresponding to the fan assembly, on the top shell 011 is a hollow-out area 014, to facilitate air out of the fan assembly, and air flow from the installation space 043 to the hollow-out area 014 is generated when the fan assembly works, in order to convey a repellent volatilizing from the installation space 043 out from the hollow-out area 014 along with air flow; the fan assembly specifically includes fan blades 030, a motor 031, a bearing 032 and a fan blade support 033, the motor 031 is installed at the top of the fan blade support 033, a connecting rod is disposed at the rear end of the fan blade 030, which is connected with the motor 031 through the connecting rod and driven by the motor, and the bearing 032 sleeves outside the connecting rod; the power supply element 050 is located on the side, close to the bottom shell 012, in the shell, and electrically connected with the control module and the fan assembly, in the application, a partition plate 042 is disposed between the power supply element 050 and the fan assembly, the installation plate 040 is fixedly installed on the side, close to the fan assembly, on the partition plate 042, and an installation space 043 is reserved between the installation plate and the fan blade support 033 in the fan assembly for installing a tablet 041. In a specific embodiment of the application, an installation groove 013 communicating with the installation space 043 is formed in the side part of the shell, and the tablet 041 is inserted in the installation space 043 through the installation groove 013.

The control module is disposed on one side of the fan assembly, and includes a circuit board 020, an indicator light 022 and a key 023, the indicator light 022 and the key 023 are installed on the side, close to the top shell 011, of the circuit board 020, in addition, a keycap 024 is further disposed on the key 023, openings are correspondingly formed in the top shell 011, so that both the key cap 024 and the indicator light 022 penetrate out of the surface of the top shell 011 to be exposed outside, a user manually presses the keycap 024 to trigger the key 023, and the work condition of the mosquito repelling fan is displayed through the indicator light 022; a power supply interface 021 is disposed on the side, far away from the fan assembly, the circuit board 020, the specific type of the power supply interface 021 is any one of USB interfaces of Type-A, Mini-B, Micro-B and Type-C, and a power supply opening is formed in the position, corresponding to the power supply interface 021, of the shell and configured for exposing the power supply interface 021 for connecting an external wire.

The tablet 041 of the application is prepared by soaking a flaky base material in a repellent, the repellent may use liquid medicines at room temperature, such as Picaridin, BAAPE (ethyl butylacetylaminopropionate), methyl nonyl ketone and DEET (N,N-Diethyl-3-methylbenzamide), in the normal use state of the tablet 041, the repellent may volatilize naturally, and the fan assembly diffuses the volatilizing repellent to environment.

In other embodiments of the application, the installation plate 040 also has the function of an electric heating plate, its temperature is controlled by the control module, meanwhile, the partition plate 042 also plays a role of separating the installation plate 040 from the power supply element 050 to reduce influence of high temperature on the power supply element 050. In the application, Picaridin is used as the repellent, the work temperature of the installation plate 040 is set to be greater than 40° C. and less than 120° C., furthermore, a plurality of temperature gears may be set in the interval, the key 023 is used for operating the startup and temperature gear adjustment of the mosquito repelling fan, and rotation speed of the fan (for example, it may be set that the key 023 is pressed for a long time for realizing startup and stop of the mosquito repelling fan, and pressed for a short time for switching temperature gear, a plurality of indicator lights 022 may be set for further indicating the temperature gear, and the rotation speed of the fan is controlled by rotating the key 023), the minimum value 40° C. of the interval is the diffusion temperature higher than the normal body temperature, and the maximum value 120° C. of the interval is the upper limit temperature of the designed maximum reasonable diffusion rate of Picaridin.

The mosquito repelling fan of the application is low in work temperature, so that the energy consumption is low, and an energy supply element with large volume and large mass does not need to be configured, so that the whole mosquito repelling fan is miniaturized, in addition, it has not requirement on specific placing angle, so that the degree of freedom during use of the user is higher.

The embodiments described above represent only several implementation modes of the application, and the description thereof is specific and detailed, but should not be construed as limiting the scope of present application accordingly. It should be pointed out that those of ordinary skill in the art can also make some modifications and improvements without departing from the concept of the present application, and these modifications and improvements all fall within the scope of protection of the present application. Accordingly, the scope of protection of the patent of the present application should be subject to the appended claims.

What is claimed is:

1. A mosquito repelling fan, used in cooperation with a tablet, comprising a shell and a fan assembly, wherein
the fan assembly is installed in the shell, an installation plate is disposed behind the fan assembly, an installation space is formed between the installation plate and the fan assembly, and the tablet is detachably installed in the installation space;
the tablet is prepared by soaking a flaky base material in a repellent, and the repellent comprises Picaridin;
a hollow-out area is disposed at a position, corresponding to an air outlet direction of the fan assembly, on the shell, and air flow from the installation space to the hollow-out area is generated when the fan assembly works, in order to convey a repellent volatilizing from the installation space out from the hollow-out area along with the air flow.

2. The mosquito repelling fan according to claim 1, wherein an installation groove is formed in the shell, the installation groove communicates with the installation space, and the tablet is inserted into the installation space from the installation groove.

3. The mosquito repelling fan according to claim 1, wherein the fan assembly comprises fan blades, a motor, a bearing and a fan blade support, the motor is installed at a top of the fan blade support, a connecting rod is disposed at the rear end of the fan blade, which is connected with the motor through the connecting rod, the motor drives the connecting rod, and the bearing sleeves outside the connecting rod.

4. The mosquito repelling fan according to claim 1, wherein the mosquito repelling fan further comprises a control module, the control module comprises a circuit board, an indicator light and a key, and the control module is electrically connected with the fan assembly.

5. The mosquito repelling fan according to claim 4, wherein the indicator light and the key are disposed on the circuit board, and the indicator light and the key are disposed facing the air outlet side of the mosquito repelling fan;
the control module further comprises a keycap installed on a surface of the key, and the keycap and the indicator light penetrate out of a surface of the shell;
a power supply interface is further disposed at an end part of one side of the circuit board, and a power supply opening is formed in the position, corresponding to the power supply interface, of the shell and configured for connecting an external wire to the power supply opening;
a type of the power supply opening is any one of USB interfaces of Type-A, Mini-B, Micro-B and Type-C.

6. The mosquito repelling fan according to claim 4, wherein the installation plate has a heating function, and a temperature of the electric heating plate is regulated and controlled by the control module;
a speed of air generated by the fan assembly is regulated and controlled by the control module.

7. The mosquito repelling fan according to claim 6, wherein the mosquito repelling fan further comprises a power supply element disposed in the shell, and the power supply element is located on the side, deviating from the fan assembly, of the installation plate;
the power supply element is electrically connected with the fan assembly and the control module, and a partition plate is lined between the power supply element and the installation plate.

8. The mosquito repelling fan according to claim 6, wherein a temperature of the installation plate has a plurality of gears, and a plurality of indicator lights are available, which respectively instructs each temperature gear of the installation plate and a switch of the mosquito repelling fan.

9. The mosquito repelling fan according to claim 8, wherein the work temperature of the installation plate is greater than 40° C. and less than 120° C.

10. The mosquito repelling fan according to claim 6, wherein the repellent further comprises one or more of BAAPE (ethyl butylacetylaminopropionate), methyl nonyl ketone and DEET (N,N-Diethyl-3-methylbenzamide).
